(19) United States
(12) Patent Application Publication
(10) Pub. No.: US 2008/0244475 A1
(43) Pub. Date: Oct. 2, 2008

(54) Network based integrated circuit testline generator

(76) Inventors: Tseng Chin Lo, Hsinchu City (TW); Kuo Tsai Li, San Jose, CA (US); Shien-Yang Wu, Hsin-Chu (TW)

Correspondence Address: SLATER & MATSIL, L.L.P., 17950 PRESTON ROAD, SUITE 1000, DALLAS, TX, 75252, US

(21) Appl. No.: 11/731,036

(22) Filed: Mar. 30, 2007

(51) Int. Cl. G06F 17/50

(52) U.S. Cl. 716/4; 716/8

(57) ABSTRACT

A network based integrated circuit testline generating system and method of using the same is described. The system includes a user interface for generating and submitting requests which specify types and configurations of needed testlines for device parametric test. A testline generator receives the requests and creates a layout data base which includes layout information of needed testlines.

### CROSS-REFERENCE TO RELATED APPLICATIONS

This application relates to the following co-pending and commonly assigned U.S. patent application Ser. No. ______, filed Mar. 30, 2007, entitled “High Accuracy and Universal On-Chip Switch Matrix Testline” (Attorney Docket No. TSM06-0412).

### TECHNICAL FIELD

The present invention relates generally to software, EDA (Electronic Design Automation) tools, and more particularly to a system and platform for creating integrated circuit testlines, such as a network based testline generator.

### BACKGROUND

In integrated circuit (IC) manufacturing, a semiconductor wafer typically contains a plurality of testlines in the scribe line area between adjacent wafer dies. Each testline includes a number of test devices, which devices are similar to those that are normally used to form the integrated circuit products in the wafer die area. By studying the parametric test results of devices on these testlines, it is possible to monitor, improve and refine a semiconductor manufacturing process.

With the continuing scale-down of IC device feature sizes, integrated circuit device density and functional complexity are continuously increasing. This trend imposes new challenges on the existing parametric testline structure and test methodologies. One of these challenges is that the testlines of advanced technology devices must include a tremendous amount of test structures to meet the test needs for advanced semiconductor devices and complex integrated circuits. However, the current testline structure can only support a limited number of test devices, as known to people skilled in the art.

Another challenge is that the parametric test results on existing testline devices are gradually losing their correlation with real integrated circuit performance, as technology advances. This is due to the fact that a typical testline structure in semiconductor manufacturing only provide generic testline devices corresponding to a specific technology node, while the circuit designers/customers might integrate customized devices/circuits (for example, proprietary IPs) in their products for achieving specific circuit functions. In current practice, these customized devices are not presented and tested on a conventional testline due to the limited available space for test devices.

Another challenge is the need to design-for-manufacturability (DFM) in advanced technology. In current practice, library and test structure designers focus more on electrical characteristics than on layout styles due to the lack of visibility on the impact of layout styles on device manufacturing yield. In order to analyze the correlation of a specific layout style to a process yield and obtain a preferred set of library/test structure layouts leading to predictable manufacturing yield on an advanced technology generation, designers need much more testing resources on a testline than they are currently offered by a conventional testline.

Another limitation of conventional testlines can be appreciated by those skilled in the semiconductor R&D field. In semiconductor manufacturing, the mass production of an integrated circuit product normally follows a long period of pilot line development stage, during which extensive design-on-experiment (DOE) and statistical split activities are carried out to obtain the optimal process parameters and reach a process flow for high manufacturing yield. Conducting DOE and statistical split involves forming a large number of the test devices under different process conditions and obtaining the optimized process parameters by statistical analysis on the test results. Due to the limitation of available test device space on a conventional testline, a large quantity of test wafers are required in order to obtain reliable statistical results. Tuning a process flow in advanced technology demands more DOE and statistical split activities, which will have a significant impact on the cost of R&D.

In view of these and other issues in a conventional parametric testline and the ever increasing testing tasks demanded by advanced technologies, a universal on-chip matrix testline (MUX testline) capable of accessing a large number of test devices was developed by the current inventors. The structures of a MUX testline and the method of using the same can be found in commonly assigned and co-pending U.S. patent application Ser. No. ______ filed on Mar. 30, 2007, and entitled “High Accuracy and Universal On-Chip Switch Matrix Testline,” which application is incorporated herein by reference. However, there remains a need for a new method of creating a MUX testline so that a circuit designer can create customized testline structures corresponding to a specific circuit/product during the early product development stage.

### SUMMARY OF THE INVENTION

This problem is generally solved or circumvented, and technical advantages are generally achieved, by preferred embodiments of the present invention which involves a network based testline generation system. This system enables a circuit designer to create a MUX testline with customized testline structures and conduct DFM evaluation on special circuit structures in very early product development stage, among other merits.

One aspect in accordance with the present invention is based on a method of forming integrated circuit testlines via a network based platform. The first step is to read a user defined testline information into a user interface. The information may include processing technology to be used, types of test devices, parameters of test devices, types of testline I/O pads, dimensions of testline pads, number of pads on a testline, and so on. The next step is to generate a request specifying the configuration of a testline from the said user interface. The generated request is sent to a server on the web, where a testline generation software program is installed. Upon receiving the request from the user interface, the testline generation software program executes a series of pre-developed testline generation commands and exports a layout database which includes layering and geometric information of needed testlines.

Another aspect in accordance with the present invention is based on a network based testline generation system. A system for generating integrated circuit testlines comprises a user interface and a server. A user of the testline generation system can specify the configuration of needed testline by reading in a user input file and other processing technology related information into the user interface. The user interface processes the information, creates a request and sends said request to said server. The server comprises a software program, which is configured to receive said request from said user interface. After executing a series of testline generation commands, the server will export a testline layout database which includes layering and geometric information of needed testlines.

Several advantageous features are provided by preferred embodiments of the present invention. A circuit design using the current system is able to create customized test devices corresponding to a specific integrated circuit product, which may lead to better correlation between test data and real product yield. The current system allows a user to conduct DFM (design-for-manufacturing) evaluation in very early product development stage, by creating and testing process sensitive circuit structures during the course of real circuit development. The Web based testline generation method saves R&D resources and costs, as can be appreciated by those skilled in the art.

### DESCRIPTION OF THE DRAWINGS

For a more complete understanding of the present invention, and the advantages thereof, reference is now made to the following descriptions taken in conjunction with the accompanying drawing, in which:

FIG. 1 is a schematic block diagram of a TVAS system in accordance with an embodiment of the current invention;

FIG. 2 shows an example of a TVAS system input in accordance with an embodiment of the current invention;

FIG. 3 is a detailed flow diagram of a TVAS system in accordance with an embodiment of the current invention;

FIG. 4A shows a section of a testline configuration file;

FIG. 4B shows a section of a testline layer definition file;

FIG. 4C shows a section of a processing technology design rule file; and

FIG. 5 shows an example of alternative routing scheme of a TVAS system.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a Test Vehicle Automation System (TVAS). TVAS is a network based MUX testline generator, which allows a circuit designer (user) to create a MUX testline comprising customized test structures (device-under-test, or DUTs) for wafer acceptance testing (WAT) and/or other R&D activities. In preferred embodiments, TVAS can be implemented on, but not limited to, an intra-net, private network, world-wide-web. The structures and method of using a MUX testline has been fully described in a commonly assigned and copending U.S. patent application Ser. No. ______ filed on Mar. 30, 2007, and entitled “High Accuracy and Universal On-Chip Switch Matrix Testline,” which application is incorporated herein by reference.

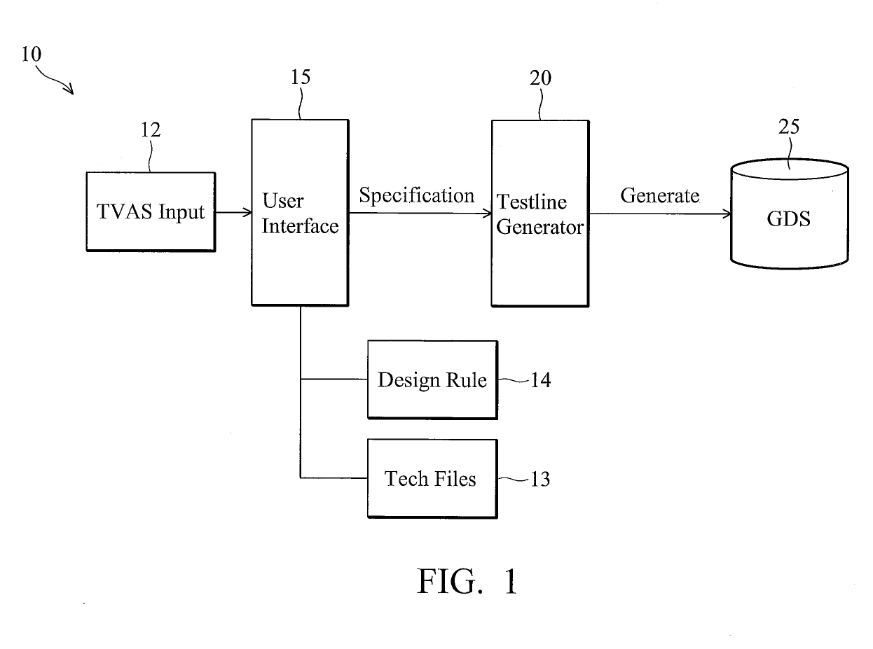

Referring now to the drawings and first to FIG. 1, there is shown a schematic block diagram of a TVAS system that includes one embodiment of the current invention. A Web based TVAS system 10 includes a user interface 15 which is configured to create a MUX testline specification and forward it to a MUX testline generator 20. User interface 15 provides a technology file table 13, which lists user selectable config files and .ld files. A config (testline configuration) file defines the configuration of a MUX testline by providing a list of available testline pad libraries and other information such as pad numbers, pad size and pad pitch on a MUX testline. An .ld (layer definition) file provides layer mapping information to map a MUX testline layer to a processing layer of a given processing technology. User interface 15 also provides a table 14 listing design rules (.dr files) of a given set of processing technologies.

In creating a testline specification in the user interface 15, a user can upload a TVAS input file 12 describing necessary DUT types, dimensions and proposed processing technology to be used into the interface 15. A user should also select the .config, .ld files in 13, and the design rule in 14 corresponding to the needed testline from the user interface 15. The user interface 15 will then generate a testline specification containing all the information and forward it to MUX testline generator 20. In preferred embodiments, the user interface 15 is an HTML (Hyper Text Markup Language), menu-driven interface and is username/passcode protected for security measures. The MUX testline generator 20 comprises a testline generation engine (main software program) installed in a server and is configured to read the specification received from the user interface 15 and generate a layout database 25 of a MUX testline with customized DUTs in the common GDS format. This system allows a user to create customized MUX testlines corresponding to a specific integrated circuit design/product via a web interface.

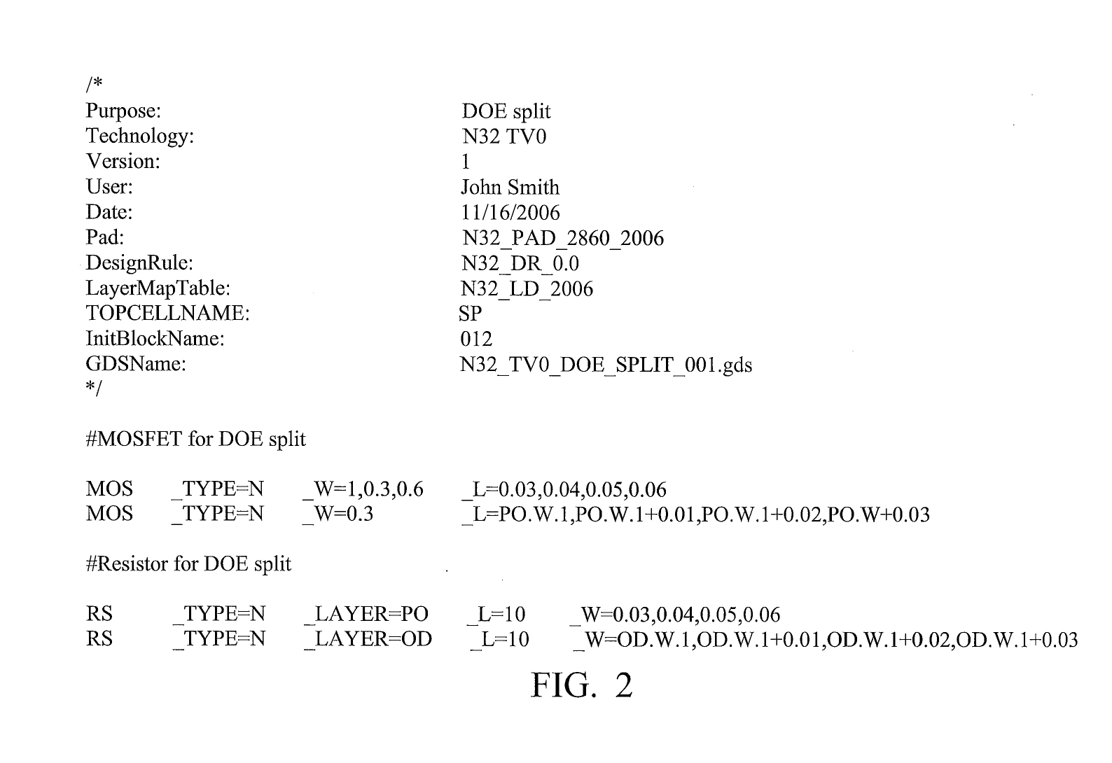

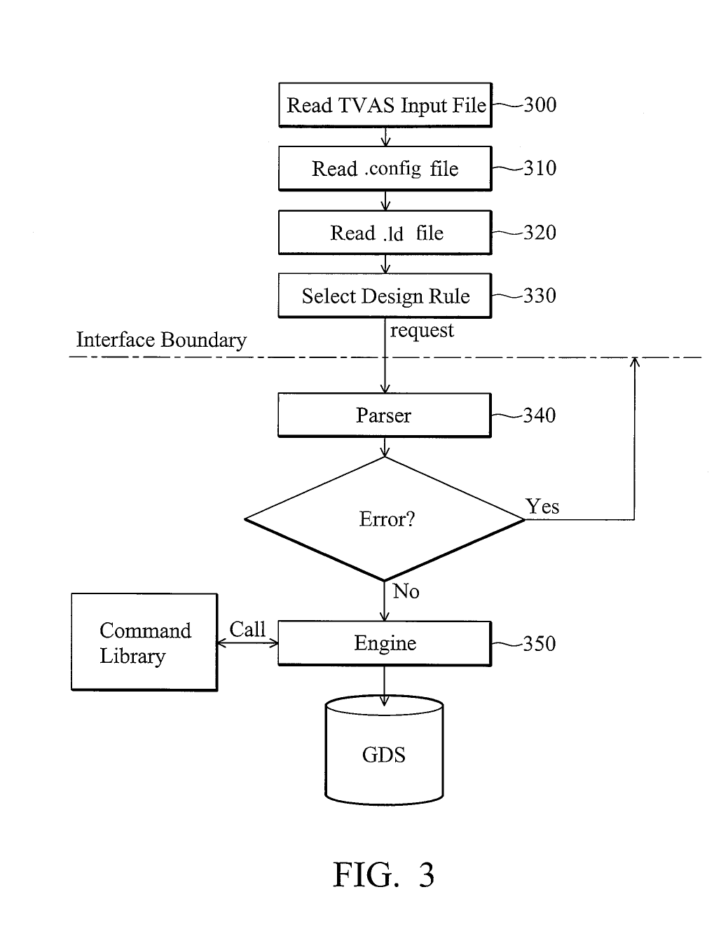

FIG. 2 is an example of TVAS input file 12 shown in FIG. 1 and provides more detailed illustration on its format and content. As shown in FIG. 2, a TVAS input file is a human readable file in ASCII format, which can be edited by conventional text editors, such as “notepad” running on an MS Windows platform or “Vi” running on an UNIX platform, just to name a few. A TVAS input file comprises four major parts, which include Header, Comments, Template key words and Parameter key words. A Header is usually located at the beginning of a TVAS input file and provides general information about a MUX testline, such as the purpose of creating the testline, processing technology to be used, the user, and the date the input file is created, and so on. In preferred embodiments, the purpose of creating a testline may include yield analysis, DOE split, SPICE model evaluation, as described in the commonly assigned and copending U.S. patent application Ser. No. ______ filed on Mar. 30, 2007, and entitled “High Accuracy and Universal On-Chip Switch Matrix Testline.” These remarks in a Header are for record keeping purpose and will be ignored by the MUX testline generator 20. Also included in a Header is technology related information which needs to be fully specified in order for the MUX testline generator 20 to create needed testlines. The technology related information may include pad library names, design rules, and layer map tables, among others. In the Header, a user can also specify top cell name, initial block name, and GDS file name in an output file, as shown in FIG. 2. These and other technology related items in a Header will be fully explained below in regard to the system flow diagram of FIG. 3. In preferred embodiments, the Header begins with a /* (a slash followed by an asterisk) and ends when a */ is encountered.

Comments are used in a TVAS input file to describe or explain each feature of a MUX testline to anyone reading the input file and will be ignored by the MUX testline generator 20. There are two types of comments in an input file. A single line comment starts with a #. A multiline comment begins with a /* and always ends with the next */.

Template keywords in a TVAS input file are uppercase identifiers with particular meanings. Each command line in a TVAS input file starts with a template keyword, which specifies the type of test device to be formed in a MUX testline. The current TVAS system of preferred embodiment supports these template keywords, such as MOS (MOS transistor), RS (sheet resistor), SERP (serpentine resistor), CONTACT (contact chain), VIA (Via chain), FUSE (electrical fuse), SRAM (Static RAM), among others. In the example shown in FIG. 2, template keywords MOS, RS specify that test devices (DUTs) to be formed in the MUX testline are MOS transistors and sheet resistors.

Parameter keywords follow a template keyword in a TVAS input file command line and are used to assign parameters to a test device. They are uppercase identifiers starting with a “_” (underscore). Parameter keywords used in the example of FIG. 2 includes “_TYPE” (semiconductor type), “_L” (MOS transistor channel length), “_W” (MOS transistor channel width), and “_LAYER” (device layers). The current TVAS system of preferred embodiment also support other parameter keywords, such as “_ROUTING” (define routing style), “_PAD” (pad type), “_ROW”, “_COL” (create device array in a test structure), “_SKIP” (skip certain feature of a test structure), “_WITH” (add certain feature of a test structure), “_DM_SR”, “_DM_SL” (spacing of dummy poly), among others. Numeric or reserved variables, such as PO, OD, PO.W.1, OD.W.1 illustrated in FIG. 2 can be assigned to a parameter keyword as test device parameters. Reserved variables with default values can be found in technology files (.config, .ld) and design rule files (.dr).

FIG. 3 is a detailed flow diagram of the TVAS system of FIG. 1. Read TVAS input file 300 reads general information about a MUX testline to be formed from the Header section of a TVAS input file, which may include technology to be used to form the test devices, pads libraries to be used for the MUX testline pads, design rules governing the chosen processing technology, and a layer map table. This step also reads the body of a TVAS input file, which specifies the test devices to be formed in a MUX testline by template keywords, parameter keywords and test device parameters assigned to parameter keywords, as described above in regard to FIG. 2.

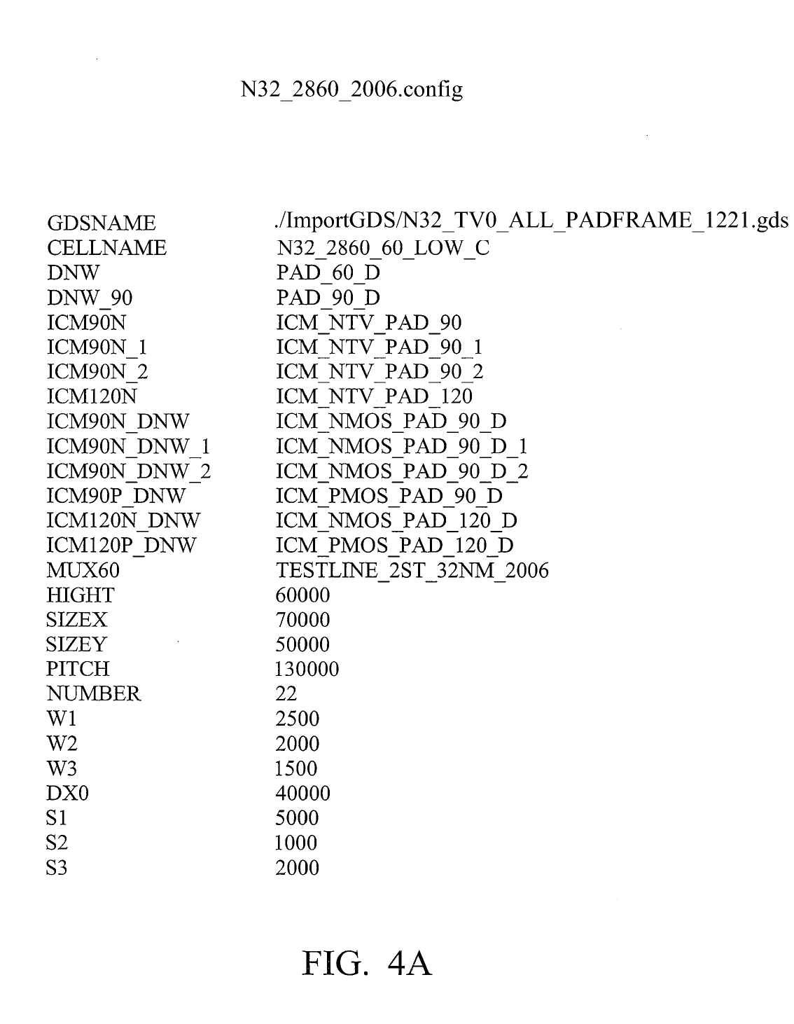

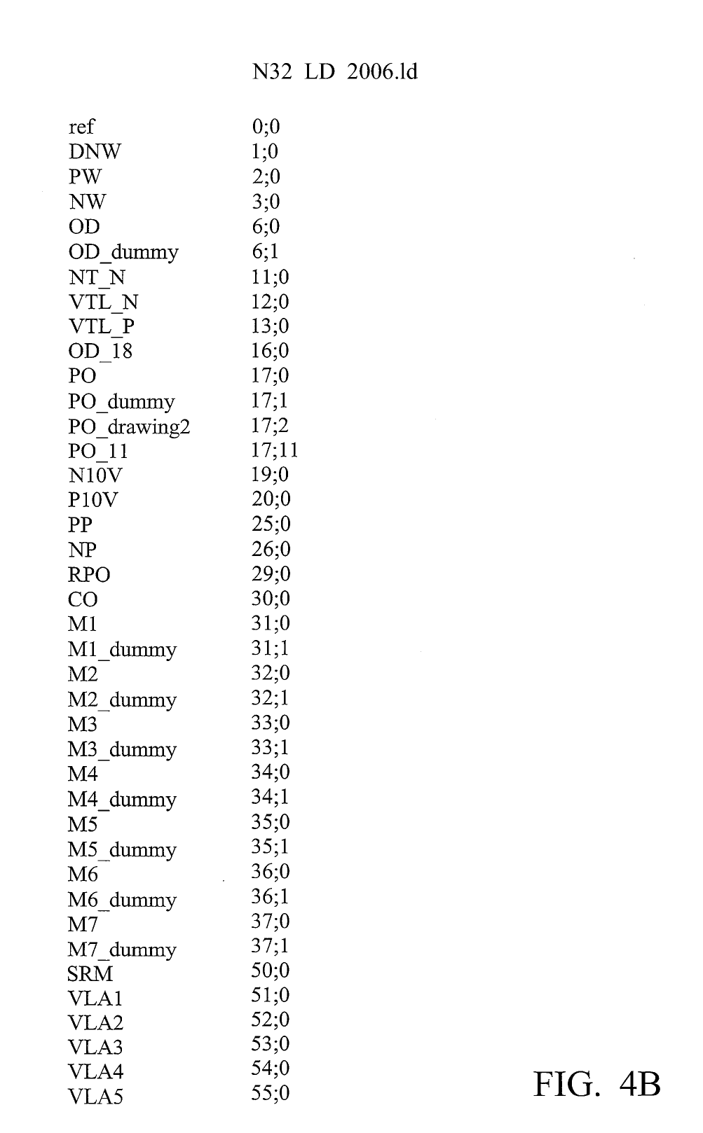

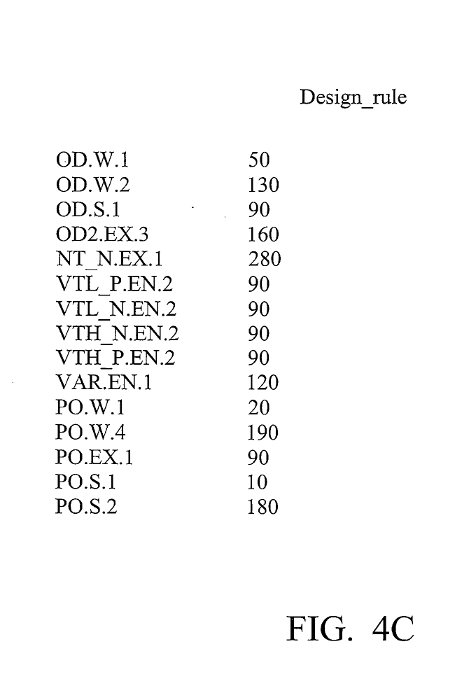

Read configuration (.config) file 310 selects a MUX testline configuration file (.config) in the user interface of a TVAS system. A config file provides a list of pre-developed I/O pads libraries made by different processing technologies and a list of default MUX testline parameters, such as pad dimensions, pad pitch size, and total number of test pads to be formed in a MUX testline, among others. A user can modify these parameters to create a customized MUX testline configuration file. FIG. 4A shows an example of a .config file. In FIG. 4A, a testline I/O pads layout database N32_TV0_ALL_PADFRAME_{—}1221.gds in GDS format is provided. The top cell name of the GDS database is N32_{—}2860_{—}60_LOW_C, which contains a plurality of pre-developed I/O pads libraries, such as PAD_{—}60_D, PAD_{—}90_D, among others. Each I/O pad library corresponds to a particular processing technology and/or application, and includes a number of pre-developed MUX testline pads. A config file as shown in FIG. 4A also includes a list of reserved arguments corresponding to each pad library. The parameter keyword “_PAD” in a TVAS input file can take one of these arguments and instruct the TVAS system to create a MUX testline with I/O pads selected from a pre-developed I/O library corresponding to the assigned argument, as illustrated in the following example:

| | | | | |
|---|---|---|---|---|
| MOS | _TYPE = N | _W = 3.6 | _L = 1.0 | _PAD = DNW_90 |

A command line in a TVAS input file as above instructs the TVAS system to create a testline for MOS transistor measurement with testline I/O pads selected from a pre-developed I/O pad library PAD_{—}90_D, corresponding to argument DNW_{—}90, as illustrated in FIG. 4A.

Read layer definition (.ld) file 320 in FIG. 3 selects a layer definition file from a technology file table in the user interface. A .ld file links a MUX testline layer to a process layer of a particular processing technology to be used in forming the MUX testline. As recognized by those skilled in the art, different integrated circuit processing technologies may include different number of processing layers to form semiconductor devices on a substrate. FIG. 4B shows an example of a .ld file used in the preferred embodiments of the current TVAS system, where a layer table is provided to map each MUX testline layer to a process layer of a given processing technology N32_LD_{—}2006, as identified by the .ld file name. A layer identifier in a .ld file can be assigned as an argument to parameter keyword “_LAYER” in a TVAS input file, as the following:

| | | | | |
|---|---|---|---|---|
| RS | _TYPE = N | _L = 10 | _W = 0.5 | _LAYER = PO |

In regard to the exemplary .ld file shown in FIG. 4B, a command line in a TVAS input file as above instructs a TVAS system to form a MUX testline with sheet resistor made of PO (poly layer) using processing technology N32_LD_{—}2006, as specified by the .ld file name.

The next step 330 in FIG. 3 selects design rule (.dr) corresponding to the processing technology specified in the TVAS input file from the user interface. As well appreciated by those skilled in the art, layout design rules of a given processing technology specify certain geometric constraints on the processing features of an integrated circuit layout. These rules are necessary for the manufacturing of reliable semiconductor devices with reasonable yields, and may include the minimum allowable line widths of interconnect layers, minimum feature dimensions, minimum dimension of diffusion areas, and so on. In preferred embodiments of the current TVAS system, Nanometer rules, in which the layout constraints are stated in terms of dimensions in nanometer, are used, although Lambda rules used in old processing technology are not excluded. FIG. 4C shows an example of a design rule file used in the current TVAS system. A feature identifier in a design rule file can also be assigned as an argument to a parameter keyword in a TVAS input file, as illustrated in the following:

| | | | |
|---|---|---|---|
| MOS | _TYPE = N | _W = 30 | _L = PO.W.1 |

In regard to the exemplary .dr file shown in FIG. 4C, a command line in a TVAS input file as above instructs TVAS system to form a MUX testline comprising an N-type MOS transistor with channel width of 30 nm and channel length of 20 nm, as specified in the .dr file. This provides a TVAS system user the benefit of input file reuse across different technology generations. A user can create MUX testline using new processing technology by reading in an existing TVAS system input file and design rule file of new processing technology generation.

It should be understood that the sequence illustrated in above steps of reading in TVAS input file and technology files is so disclosed to convey the concept of the present invention to those skilled in the art. The actual order of reading the TVAS input file and technology files into the TVAS system user interface is less significant, so long as the files are properly created and read into the TVAS system user interface.

After reading in TVAS input file and technology files as illustrated through above steps, a request specifying the configuration of a MUX testline is generated from the TVAS system interface and sent to the TVAS system MUX testline generator installed in a server. In preferred embodiment of the current TVAS system, the testline generator is an executable file running on an UNIX platform, which includes three parts, a parser, a MUX testline generation engine, and a command library.

As shown in step 340 of FIG. 3, a parser first carries out syntax analysis on the MUX testline request generated from the TVAS system user interface. The parser will also check the consistency among the technology files selected for the formation of the MUX testline test devices and testline I/O pads. If syntax errors are found in the TVAS system input file and/or technology files are found miss-matching with each other, no further execution needs to be performed and an error message is returned to the user interface.

If no syntax errors and/or technology file miss-match are found, MUX testline generation engine starts to create the MUX testline as shown in step 350, which includes forming a plurality of test devices specified in a TVAS system input file using processing technology identified by the name of the layer definition file (.ld), forming a selection circuit (selection circuit in preferred embodiments is described in the commonly assigned and copending U.S. patent application Ser. No. ______ filed on Mar. 30, 2007, entitled “High Accuracy and Universal On-Chip Switch Matrix Testline.” using processing technology identified by the name of the layer definition file (.ld), and forming MUX testline I/O pads selected from preferred I/O pad layout database identified in the Header section of the TVAS system input file.

In creating a MUX testline test device, the MUX testline generation engine running on a UNIX platform calls a pre-developed test device generation procedure stored in a command library, such as binary files under root directory usr/bin, and executes the procedure with device parameters specified in the TVAS input file. In one embodiment, the testline generation engine and other test device generation procedures are compiled C-source. In other embodiments, testline generation engine and test device generation procedures are created by scripting languages such as, Perl (Practical Extraction and Report Language), or Tcl (Tool Command Language), although scripts created by other computer languages are not excluded. After forming one test device, the main program of the testline generation engine calls and executes another test device generation procedure in the command library to create the next test device. This process repeats until all test devices identified in the TVAS input file are formed. After formation of the test devices, the testline generation engine will also create selection circuit and testline I/O pads by calling corresponding procedures in the command library.

In another embodiment, the testline generator of a TVAS system is an executable file (.exe) running on an MS Windows platform and includes a main MUX testline generation function and a dynamic link library (DLL), which comprises a plurality of complied functions (DLL files) for creating testline devices, selection circuits, and testline I/O pads. The process of creating a MUX testline in current embodiment is similar to the steps described above.

After the completion of above steps, the testline generation engine will export a layout database in the common GDS format, which includes all layering and geometric information regarding formed MUX testlines, enough for manufacturing. In preferred embodiments of the current TVAS system, a user can name the generated MUX testline layout database in the Header section of a TVAS input file. A testline in the exported GDS database is named by the top cell name of the GDS database followed by the initial block name specified in the Header of a TVAS input file.

A MUX testline created by a preferred embodiment of the current TVAS system comprises up to 256 DUTs (device-under-test), a selection circuit, and 22 standard 2.5V I/O pads. Among the I/O pads, ten are address pads connecting to the selection circuit and eight are sensing/forcing pads for applying stimuli to and retrieving responses from a selected DUT. A MUX testline thus created also includes one power pad, one ground pad, one clock pad, and one redundant pad.

The preferred embodiments of the current TVAS system provide a variety of advantageous features to facilitate a TVAS system user to create customized MUX testline for various needs as shown in above. The following are a few examples serving to illustrate further features of significance.

The current TVAS system supports multiply value assignment to a parameter keyword, as shown in the following example:

| | | | |
|---|---|---|---|
| MOS | _TYPE = N | _W = 1, 0.6 | _L = 0.03, 0.04, 0.05 |

a command line in a TVAS input file as above will create 6 MOS transistors on a MUX testline as following:

NMOS 1, W=1, L=0.03

NMOS 2, W=1, L=0.04

NMOS 3, W=1, L=0.05

NMOS 4, W=0.6, L=0.03

NMOS 5, W=0.6, L=0.03

NMOS 6, W=0.6, L=0.03

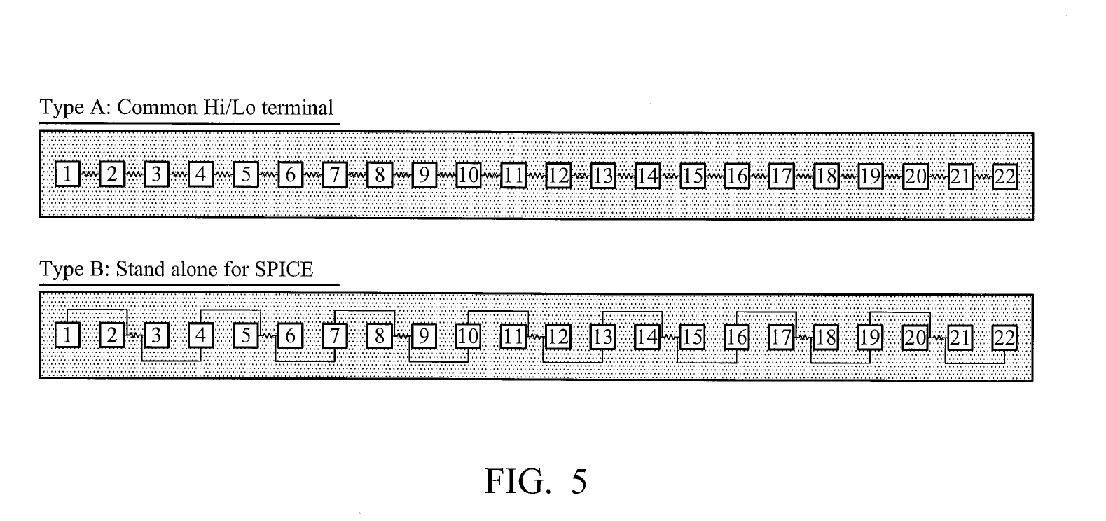

The current TVAS system facilitates a user alternative routing styles when default routing scheme encounters potential issue of routing congestion or alternative routing is needed to serve special purpose, as illustrate in the example regarding FIG. 5. In FIG. 5, a resistor chain is created by default routing scheme Type A. By specifying alternative routing scheme Type B in the input file as following:

| | | | | |
|---|---|---|---|---|
| RS | _TYPE = N | _W = 10, 15, 20 | _L = 10, 20, 30 | _ROUTING = |
| | | | | B |

Nets are routed for the convenience of evaluating SPICE model of individual sheet resistor.

The current TVAS system supports TVAS input file comprising large number of test devices and forms GDS database comprising plurality of MUX testlines. Positions of DUTs on a MUX testline are automatically arranged by default algorithm. However, the current TVAS system also offers user the flexibility of arranging DUTs on a MUX testline in customized order by placing parameter keyword “NEXT” and “NEW” in front of a template keyword, as illustrated in the following example:

| | | | |
|---|---|---|---|
| MOS | _TYPE = N | _W = 3.6 | _L = 10 |
| NEXT | | | |
| ICM | _TYPE = N | _W = 20 | _L = 5 |
| NEW | | | |
| RS | _TYPE = N | _W = 30 | _L = 30 |

Instead of positioning test device ICM next to test device MOS, Parameter keyword “NEXT” moves device ICM to another position on a same testline. Parameter keyword “NEW” moves device RS to a new testline.

The current TVAS system offers another powerful feature to users, which allows a user to define new template keywords and parameter keywords and create corresponding command procedures. A user defined procedure can be compiled C-source or scripts created by Tcl (tool command language), Perl (practical extraction and report language), among others

Above are just a few examples demonstrating the various features available for a TVAS system user and are intended merely to facilitate further understanding of ways the preferred embodiments of the current invention can be practiced. Therefore, these examples should not be construed as limiting the scope of the current invention.

Although the present invention and its advantages have been described in detail, it should be understood that various changes, substitutions and alterations can be made herein without departing from the spirit and scope of the invention as defined by the appended claims. For example, the inventive concept of creating customized MUX testline on a network based platform described above may also applies to a conventional testline.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of forming integrated circuit testlines comprising:
reading testline information into a user interface;
generating by said user interface a request;
sending said request to a testline generator; and
generating by said testline generator a database, wherein said database comprises layout information of said integrated circuit testlines.

2. The method of claim 1 wherein reading testline information comprises the steps of:
reading a user input file into a user interface;
reading a testline configuration file into said user interface;
reading a layer definition file into said user interface; and
reading design rules into said user interface.

3. The method of claim 2 wherein said user input file is a human readable file in ASCII format, which comprises information, such as processing technology to be used in forming a testline/testlines, DUT types, DUT parameters, pad library names, name of design rule file, name of layer map table.

4. The method of claim 2 wherein said testline configuration file is a human readable file in ASCII format, which comprises information, such as names of pre-developed testline I/O pad libraries, pad dimensions, number of pads on a testline.

5. The method of claim 2 wherein said layer definition file is a human readable file in ASCII format, which comprises a lookup table mapping a testline layer to a process layer of a given processing technology.

6. The method of claim 1 wherein said request specifies the configuration of testline needed.

7. The method of claim 1 wherein said user interface is an HTML interface.

8. The method of claim 1 wherein generating said testline generator is a software program.

9. The method of claim 8 wherein said software program runs on a UNIX platform and comprises a main program and a command library, wherein pre-developed functions and/or user defined subroutines installed in said command library may be called and executed by said main program to create testline structures.

10. The method of claim 8 wherein said software program is an executable file (.exe) running on an MS Windows platform and includes a main program and a dynamic link library (DLL) comprising a plurality of complied functions, which can be called and executed by said main program to create testline structures.

11. A system for generating integrated circuit testlines comprises:
a user interface for creating and submitting a request, wherein said request specifies configuration of testlines needed; and
a server configured to receive said request from said user interface and create a layout database of said testlines in response to said request.

12. The system of claim 11 wherein said user interface provides a technology file table, which lists user selectable testline configuration files, layer definition files, and design rule files.

13. The system of claim 12 wherein said testline configuration file provides a list of available testline pad libraries and other user definable information such as pad numbers, pad size and pad pitch on a MUX testline.

14. The system of claim 12 wherein said layer definition file comprises a lookup table mapping a testline layer to a process layer of a given processing technology.

15. The system of claim 11 wherein said server comprises an executable testline generation software program.

16. The system of claim 15 wherein said software program comprises a parser, a main program and a command library running on a UNIX platform.

17. The system of claim 15 wherein said software program comprises a main function and a DLL library.
